(19) United States
(12) Patent Application Publication
(10) Pub. No.: US 2026/0202625 A1
(43) Pub. Date: Jul. 16, 2026

(54) OPTICAL TRANSMISSION DEVICE AND COMBINATION METHOD THEREOF

(71) Applicant: QuantumZ Inc., KAOHSIUNG CITY (TW)

(72) Inventors: CHUN-CHIEH CHEN, KAOHSIUNG CITY (TW); PO-TING CHEN, KAOHSIUNG CITY (TW); CHAO-HUI KUO, KAOHSIUNG CITY (TW); CHIA-JUNG CHANG, KAOHSIUNG CITY (TW)

(21) Appl. No.: 19/563,319

(22) Filed: Mar. 11, 2026

Related U.S. Application Data
(62) Division of application No. 17/972,341, filed on Oct. 24, 2022, now Pat. No. 12,631,834.

(30) Foreign Application Priority Data
Oct. 26, 2021 (TW) 110139678

(51) Int. Cl. G02B 6/42

(52) U.S. Cl. CPC G02B 6/4212; G02B 6/4214; G02B 6/4224; G02B 6/423; G02B 6/4249; G02B 6/4284

(57) ABSTRACT

An optical transmission device is provided, including: a substrate, including an end face, an optical transmission channel exposed on the end face, and a first positioning portion; a jumper, including a mounting portion contacting the end face and a second positioning portion positioned with the first positioning portion; and an optical fiber, mounted to the mounting portion, an end face of the optical fiber corresponding to the optical transmission channel. The combination method of the optical transmission device includes steps of: forming a first hole on a substrate including an optical transmission channel; filling the first hole with a filling material; forming an alignment mark on the filling material within the first hole; forming a second hole on the substrate based on the alignment mark; and connecting a jumper to the second hole and make the jumper abutted against the substrate.

### BACKGROUND OF THE INVENTION

### FIELD OF THE INVENTION

The present invention is a Divisional application of application Serial No. 17/972341, filed 10/24/2022, the entire contents of which are hereby incorporated by reference.

### DESCRIPTION OF THE PRIOR ART

In recent years, the rapid development of network results in requirement of larger and larger bandwidth. Conventionally, transmission of signal is carried out by using electric current, in which the signal is transmitted in a coaxial cable by changing properties of DC and AC. The development of the network has made the transmission speed and bandwidth insufficient, so there is an optical transmission way raised for transmitting signals to replace the conventional electrical transmission way for transmitting signals.

In optical communication, an optical waveguide is generally less than 1 μm in dimension. Since the diameter of the core of a single-mode optical fiber is about 10 μm, there is a large dimensional difference between the optical waveguide and the core of a single-mode optical fiber. Furthermore, it allows just little coupling alignment tolerance during packaging. As such, there will be considerable loss between the optical fiber and the optical waveguide.

The conventional active optical fiber coupling has problems such as poor coupling efficiency and little assembling tolerance, and is not suitable for high-speed transmission (more than 10G). Compared to the conventional active optical fiber coupling, the conventional passive lens optical fiber coupling has advantages such as higher coupling efficiency and large assembling tolerance, and is suitable for high-speed transmission (10G~400G); however, the cost of lens development is higher. In addition, there are many and complicated steps in the above-mentioned conventional optical fiber coupling methods, and it requires more time for coupling.

The present invention is, therefore, arisen to obviate or at least mitigate the above-mentioned disadvantages.

### SUMMARY OF THE INVENTION

The main object of the present invention is to provide an optical transmission device and a combination method thereof, which is beneficial for aligning an optical fiber and an optical transmission channel easily, quickly and precisely, and provides high coupling efficiency.

To achieve the above and other objects, an optical transmission device is provided, including: a substrate, including an end face, an optical transmission channel and a first positioning portion, the optical transmission channel being exposed on the end face; a jumper, including a mounting portion and a second positioning portion, the mounting portion contacting the end face of the substrate, the second positioning portion and the first positioning portion being positioned with each other; and an optical fiber, mounted to the mounting portion, an end face of the optical fiber corresponding to the optical transmission channel.

To achieve the above and other objects, a combination method of an optical transmission device is provided, including steps of: forming a first hole on a substrate including an optical transmission channel; filling the first hole with a filling material; forming an alignment mark on the filling material within the first hole; forming a second hole on the substrate based on the alignment mark; and connecting a jumper to the second hole and make the jumper abutted against the substrate.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention;

FIG. 2 is a breakdown drawing of the first preferable embodiment of the present invention;

FIGS. 3 and 4 are drawings showing assembling of the first preferable embodiment of the present invention;

FIG. 5 is a partial cross-sectional view of the first preferable embodiment of the present invention;

FIG. 6 is a partial enlargement of FIG. 5;

FIG. 7 is a cross-sectional view of the first preferable embodiment of the present invention;

FIG. 8 is a partial enlargement of FIG. 7;

FIGS. 9 and 10 are drawings showing assembling of a second preferable embodiment of the present invention;

FIG. 11 is a stereogram with a partial cross-section of the second preferable embodiment of the present invention;

FIG. 12 is a cross-sectional view of the second preferable embodiment of the present invention;

FIGS. 13 and 14 are drawings showing assembling of a third preferable embodiment of the present invention;

FIG. 15 is a cross-sectional view of a fourth preferable embodiment of the present invention;

FIG. 16 is a cross-sectional view of a fifth preferable embodiment of the present invention; and

FIGS. 17 to 23 are drawings showing formation of a first positioning portion on a substrate according a preferable embodiment of the present invention.

### DETAILED DESCRIPTION OF THE PREFERRED EMBODIMENTS

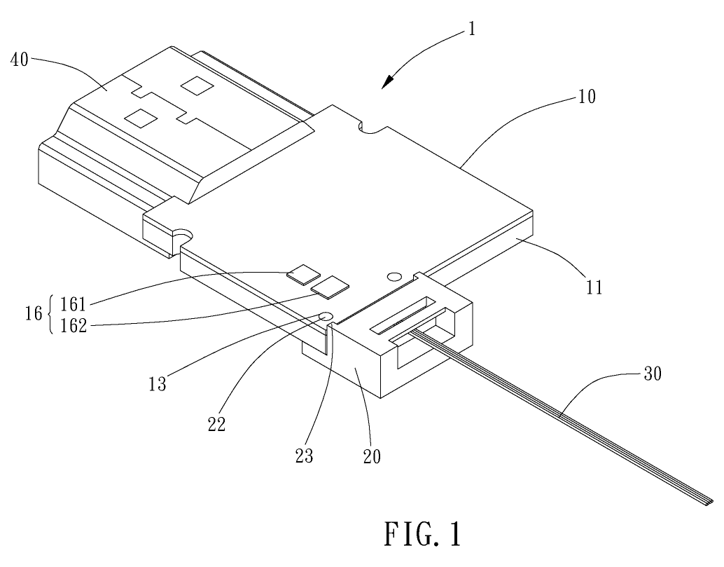

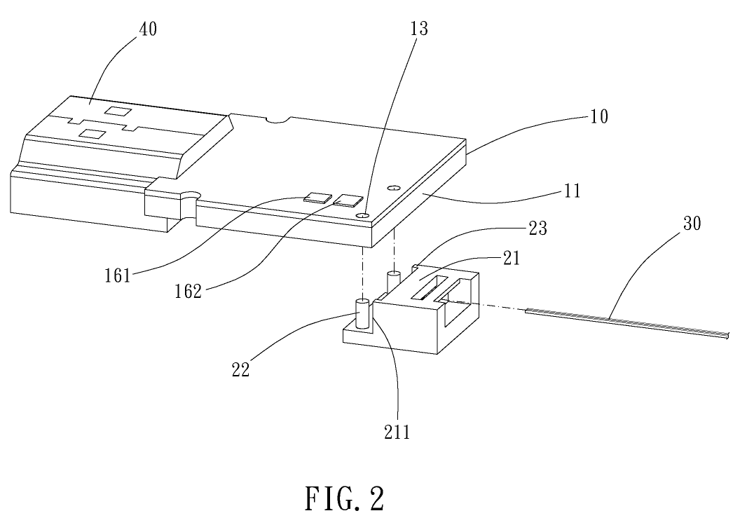

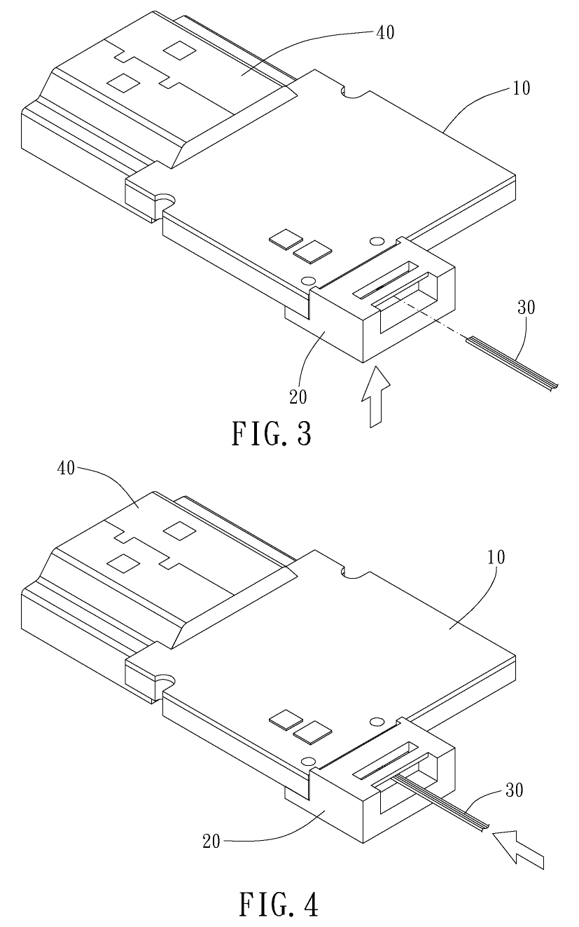

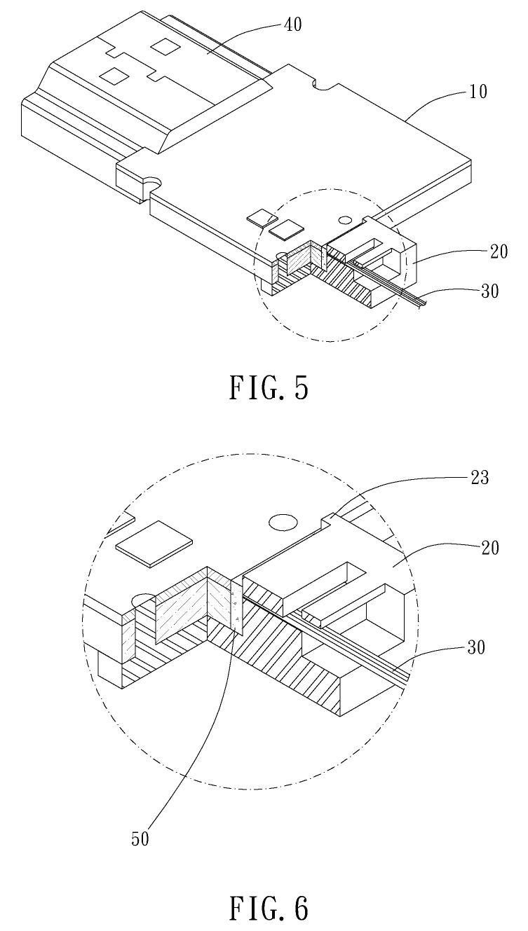

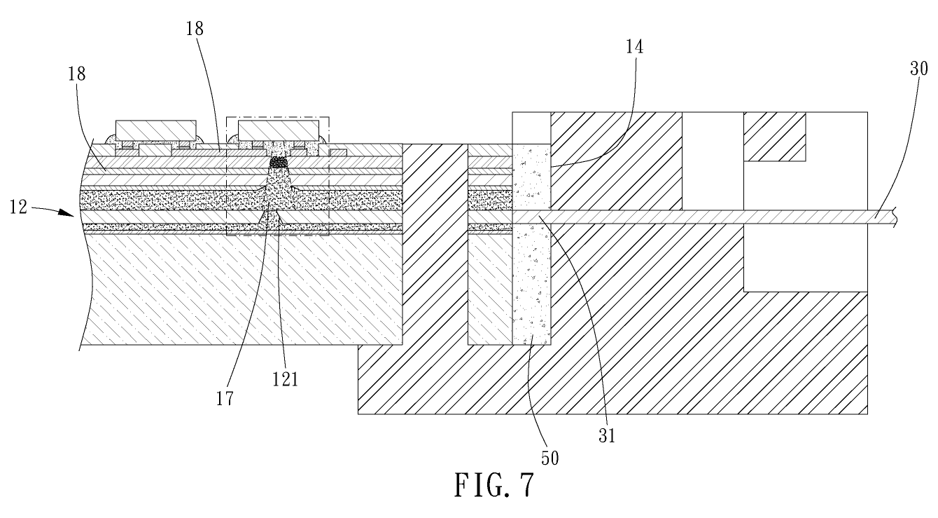

Please refer to FIGS. 1 to 8 for a preferable embodiment of the present invention. An optical transmission device 1 of the present invention includes a substrate 10, a jumper 20 and an optical fiber 30.

The substrate 10 includes an end face 11, an optical transmission channel 12 and a first positioning portion 13, and the optical transmission channel 12 is exposed on the end face 11. The jumper 20 includes a mounting portion 21 and a second positioning portion 22, the mounting portion 21 contacts the end face 11 of the substrate 10, and the second positioning portion 22 and the first positioning portion 13 are positioned with each other. The optical fiber 30 is mounted to the mounting portion 21, an end face of the optical fiber 30 corresponds to the optical transmission channel 12 (for example, the end face of the optical fiber 30 faces the optical transmission channel 12) so that the light can be transmitted in the optical transmission channel 12 and the optical fiber 30. The end face 11 may any of sides of the substrate 10, or may be any region on an inner face of a recess of the substrate 10. In this embodiment, the first positioning portion 13 is a positioning hole, and the second positioning portion 22 is a column configured to be inserted in the positioning hole; however, the first positioning portion 13 may be a column, and the second positioning portion 22 is a positioning hole. It is noted that each of the column and the positioning hole may be of any suitable shape. In other embodiments, the first positioning portion and the second positioning portion may be members which are magnetically attractive to each other or may be male and female members which are connectable to each other.

The substrate 10 further includes a connector 40, and the connector 40 may be a HDMI, USB or USB-C connector, which greatly reduces the size and components of the package. The optical fiber 30 and the optical transmission channel 12 can be easily connected to each other by connection of the first positioning portion 13 and the second positioning portion 22. As such, the required transmission efficiency can be achieved without the need for optical coupling with lenses, which can reduce packaging, coupling, alignment procedures and time, and the substrate 10 and the jumper 20 can be assembled precisely so that it provides high coupling efficiency.

In this embodiment, an end face of the optical transmission channel 12 is located between the first positioning portion 13 and the end face of the optical fiber 30; the jumper 20 further includes at least one flange 23 abutted against the end face 11 of the substrate 10; the at least one flange 23 and the second positioning portion 22 define a distance therebetween equal to a distance between and the end face 11 of the substrate 10 and the first positioning portion 13, and the end face of the optical fiber 30 is substantially aligned with and an end face of the flange 23; the mounting portion 21 includes an abutting surface 211 abutted against the end face 11 of the substrate 10, and a distance between the first positioning portion 13 and the end face 11 of the substrate 10 is equal to a distance between the second positioning portion 22 and the abutting surface 211. As such, the substrate 10 and the jumper 20 can be connected and positioned very precisely, and the optical fiber 30 and the optical transmission channel 12 can correspond to each other precisely, which increase the coupling efficiency.

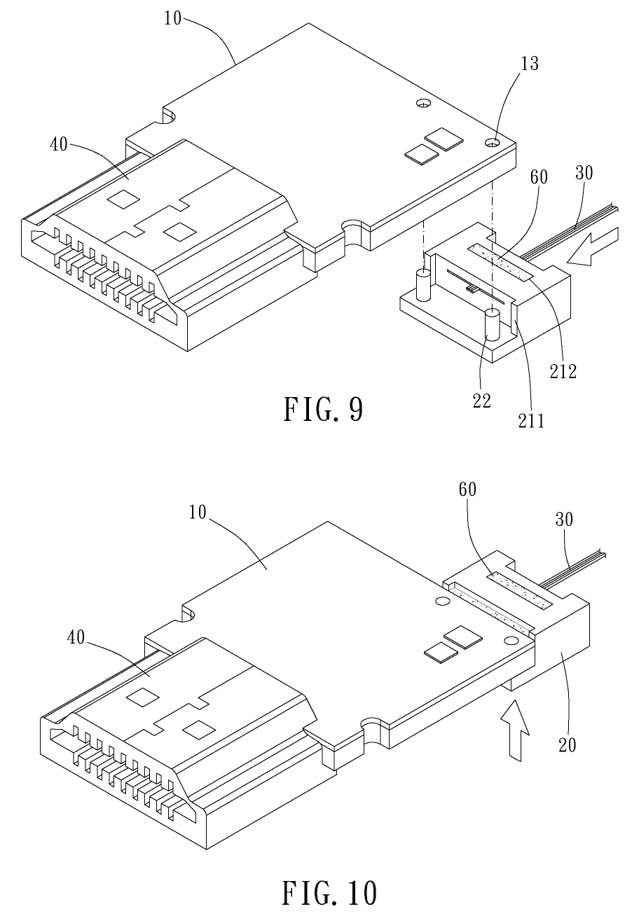

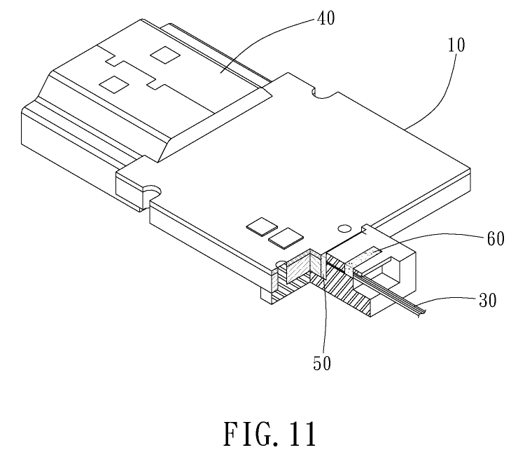

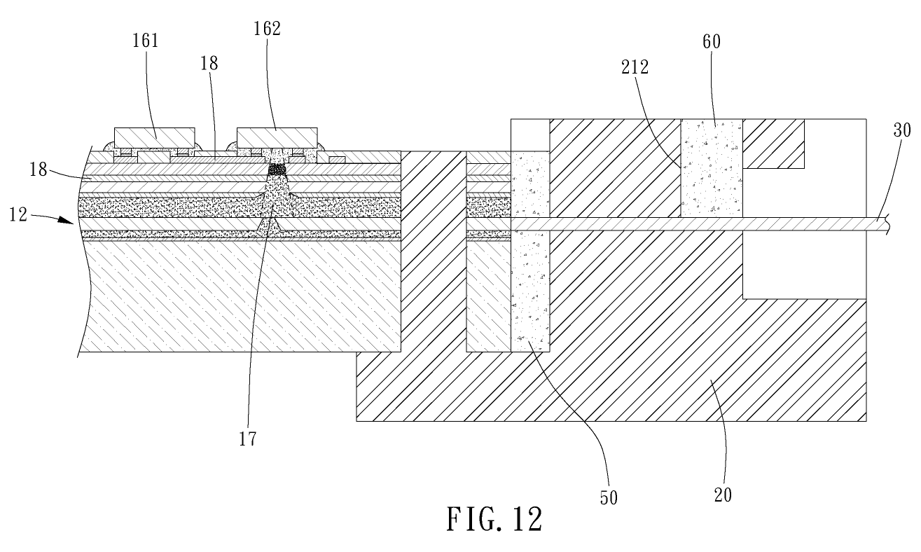

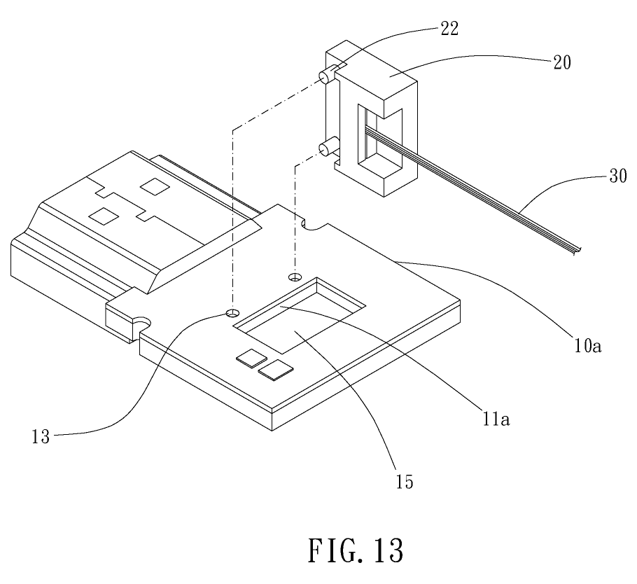

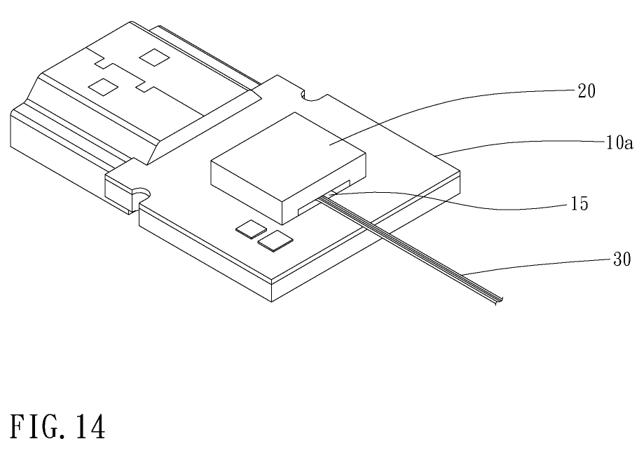

The end face 11 of the substrate 10 and the mounting portion 21 form a gap 14 therebetween, the optical fiber 30 includes an end portion 31 projecting within the gap 14, and an optical material 50 (such as refractive index resin or other material with suitable refractive index) is disposed in the gap 14 and binds the end portion 31 of the optical fiber 30, wherein the optical material 50 can improve the transmission efficiency. In a second preferable embodiment shown in FIGS. 9 to 12, the optical fiber 30 may be secured to the mounting portion 21 first, and the jumper 20 is then inserted to the substrate 10. For example, the mounting portion 21 includes a slot 212 on a side thereof, the optical fiber 30 is disposed through the slot 212, a binder 60 (such as UV resin or other suitable adhesive) is disposed in the slot 212 and binds the optical fiber 30, the optical material 50 is then disposed in the gap 14 and binds the end portion 31 of the optical fiber 30, so that the optical fiber 30 and the optical transmission channel 12 can be aligned with and positioned to each other easily, quickly and precisely. In a third preferable embodiment shown in FIGS. 13 and 14, the substrate 10a further includes a recess 15, the recess 15 includes the end face 11a, the first positioning portion 13 is located beside the recess 15, and the jumper 20 is engaged within the recess 15.

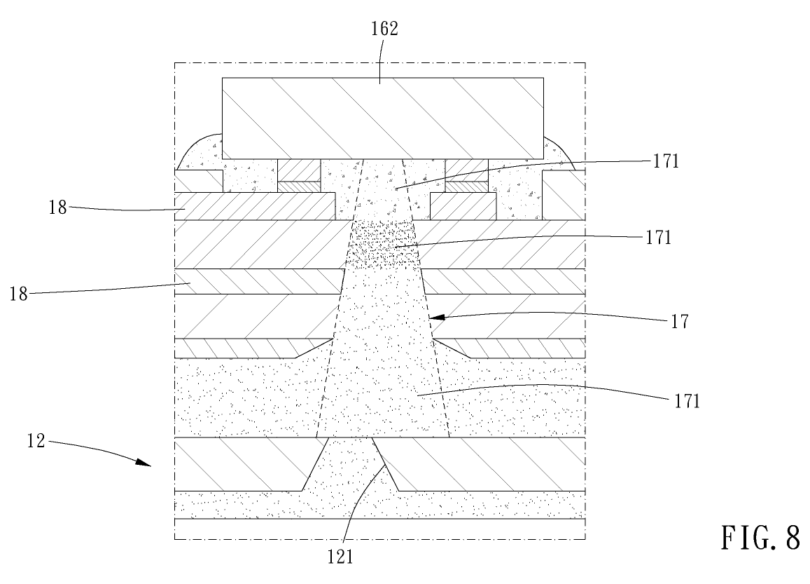

Please refer to FIGS. 1 to 8 again, the substrate 10 further includes a photoelectric conversion module 16, the photoelectric conversion module 16 includes an integrated circuit package 161 and an optical component 162 connected to the integrated circuit package 161, the optical component 162 corresponds to a reflective surface 121 of the optical transmission channel 12, and the optical component 162 includes a photoelectric conversion element (optical receiver) or a photoelectric emitting element (optical transmitter). The substrate 10 further includes a refractor 17 (the portion shown by dotted lines in FIG. 8), the refractor 17 is connected between the optical component 162 and the reflective surface 121, and the refractive index of the refractor 17 progressively increases (at the transmitting (Tx) end) or progressively decreases (at the receiving (Rx) end) from the optical component 162 to the reflective surface 12. The substrate 10 further includes at least one circuit layer 18, the at least one circuit layer 18 may be (but not limited to) provided in a flexible printed circuit (FPC), the at least one circuit layer 18 is connected to the connector 40, the photoelectric conversion module 16, the integrated circuit package 161 and the optical component 162.

As shown in FIG. 8, the refractor 17 includes a plurality of refractive layers 171 of different refractive indices. One of the plurality of refractive layers 171 connected to the optical transmission channel 12 may be constructed by a part of a cladding of the optical transmission channel 12, or may be constructed by a part of an adhesive layer (bonding sheet) or polyimide (PI) layer between a core layer of the optical transmission channel 12 and the flexible printed circuit.

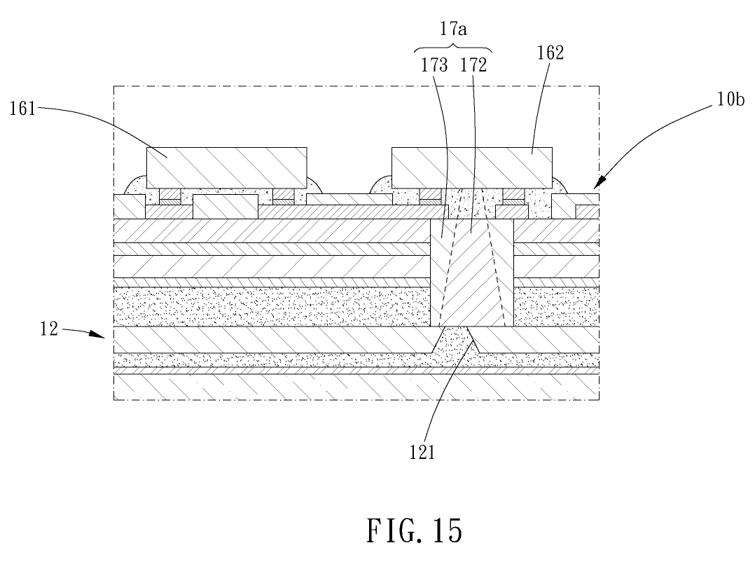

In a fourth preferable embodiment shown in FIG. 15, the substrate 10b includes a light-guiding portion 17a, the light-guiding portion 17a is located between the optical component 162 and the reflective surface 121, and the light-guiding portion 17a includes a core 172 which extends form the optical component 162 toward the reflective surface 121 and a cladding 173 which is coated around the core 172. The light-guiding portion 17a has a structure similar to that of the optical fiber, and optical signals can be efficiently transmitted in the light-guiding portion 17a. In this embodiment, the core 172 is a cone, and the diameters of the opposite ends of the cone are 60 μm and 100 μm, respectively. However, the shape of the core 172 and the diameters of the opposite ends of the core 172 may be different according to various different optical properties and requirements.

Please refer to FIGS. 1 to 8 again, the electrical signal from the connector 40 can be transmitted to the integrated circuit package 161 via the at least one circuit layer 18, the integrated circuit package 161 then controls the photoelectric emitting element based on the electrical signal to generate an optical signal, the optical signal passes through the refractor 17 and is reflected by the reflective surface 121 to come into the optical transmission channel 12, and the optical signal is then transmitted outside via the optical fiber 30; or, the optical signal from the optical fiber 30 may enter the optical transmission channel 12 and be reflected by the reflective surface 121 to pass through the refractor 17 and then received by the photoelectric conversion element, the photoelectric conversion element converts the optical signal into an electrical signal which can be passed through a transimpedance amplifier (TIA) and then transmitted to the connector 40 via the at least one circuit layer 18 for inputting the electrical signal into an electron device.

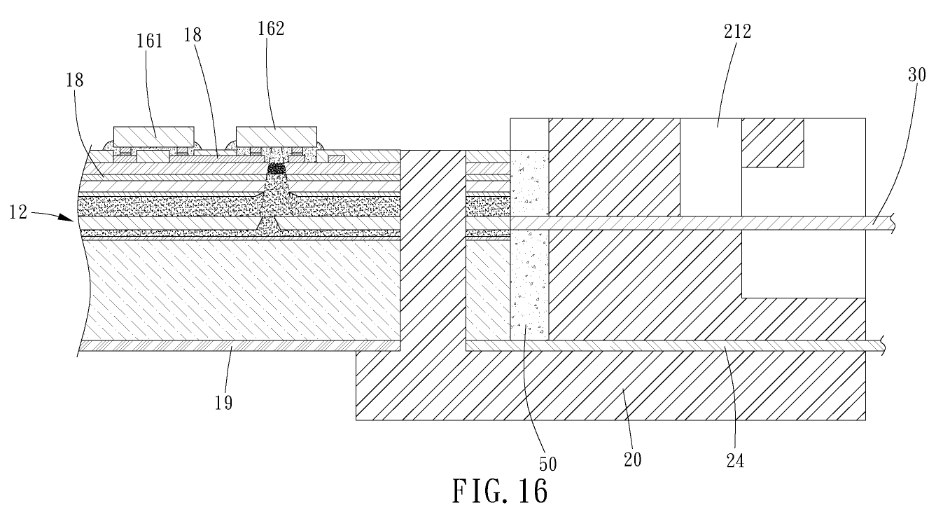

In a fifth preferable embodiment shown in FIG. 16, the substrate 10 may further include a circuit layer 19, the circuit layer 19 is disposed at a side opposite to the optical transmission channel 12, the jumper 20 further includes a transmission circuit 24 (such as wire, coaxial cable, or other conductive member) electrically connected to the circuit layer 19. The circuit layer 19 and the connector 40 are electrically connected to each other for transmitting the electrical signal from the connector 40 (connected to an output terminal of an electronic device) to outside via the transmission circuit 24 of the jumper 20, or for transmitting the electrical signal from the transmission circuit 24 of the jumper 20 (connected to an output terminal of an electronic device) via the circuit layer 19 from the connector 40 to another electronic device. The transmission circuit may be provided in a USB-C cable, which allows either of electrical transmission and charging.

According to the structural described above, the connector 40 may include one or more sets of electrical pins, and the one or more sets of electrical pins can be configured as to be connected to at least one of the circuit layer 18 and the circuit layer 19, which provides photoelectric conversion of signal transmission mode.

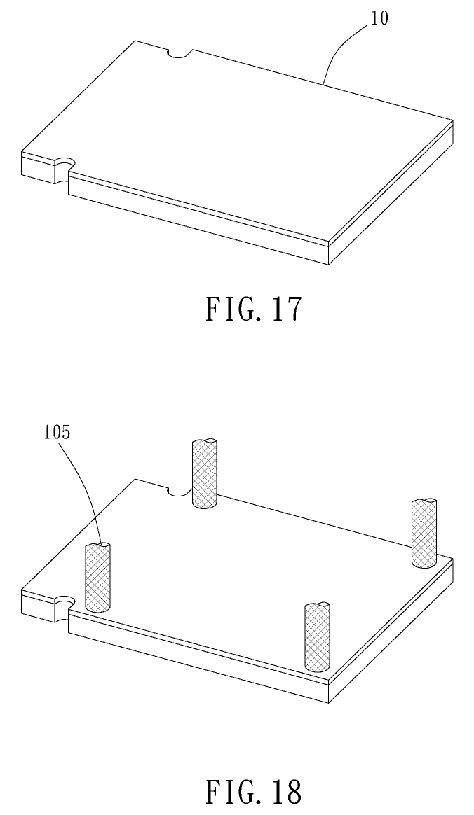

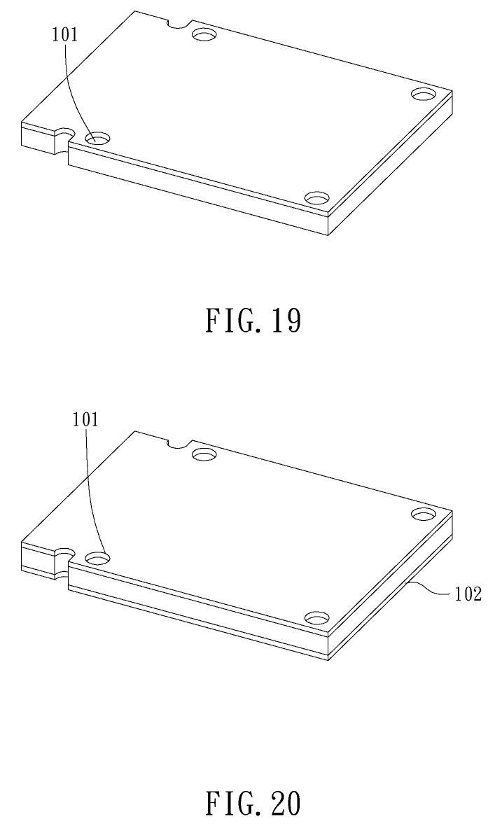

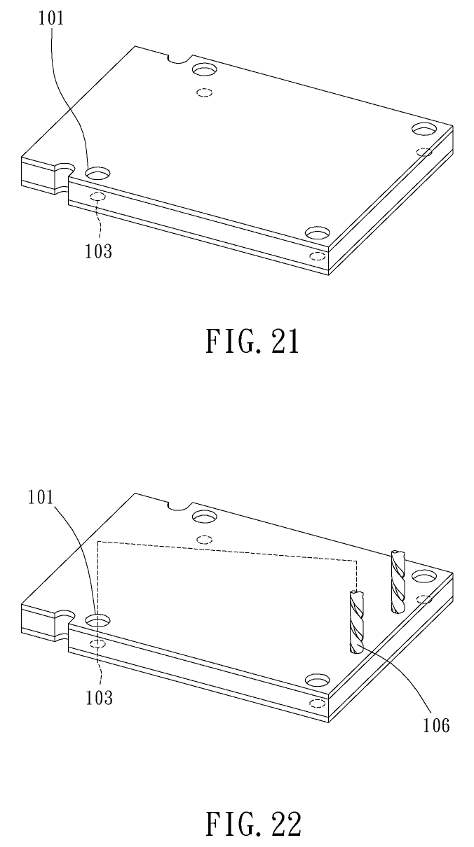

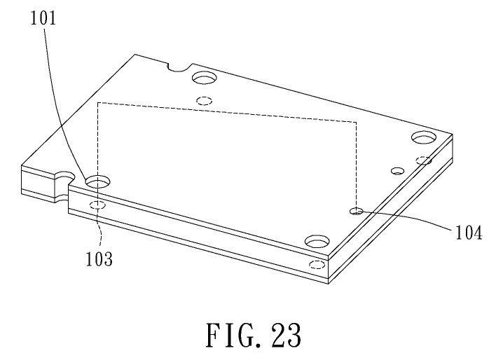

Please refer to FIGS. 1-8 and 17-23, the present invention a combination method of an optical transmission device. The combination method includes following steps of: forming a first hole 101 on a substrate 10 including an optical transmission channel 12; filling the first hole 101 with a filling material 102; forming an alignment mark 103 on the filling material 102 within the first hole 101; forming a second hole 104 on the substrate 10 based on the alignment mark 103, wherein the second hole 104 servers as the first positioning portion 13 of the substrate 10; and connecting a jumper 20 to the second hole 104 and make the jumper 20 abutted against the substrate 10. The first hole 101 and the second hole 104 may be formed by at least one punch pin 105 or drill 106. Preferably, the first hole 101 and the alignment mark 103 have a common center, the machining precision of forming the second hole 104 is less than or equal to ±5 μm, ensuring the precision of alignment of the optical fiber 30 and the optical transmission channel 12.

The alignment mark 103 may be a notation, hole (the periphery of the first hole 101 or another hole) or any pattern(s). The filling material 102 may be (but not limited to) photoresist) or other non-conductive material. Preferably, the filling material 102 is light-penetrable so that the position of the filling material 102 under and corresponding to the optical transmission channel 12 (preferably provided with any type of alignment mark) can be obtained. As such, the precise position of the end face of the optical transmission channel 12 relative to the first hole 101 or to the alignment mark 103 (the reference center for processing the second hole 104) can be ascertain, so the precision of forming the second hole 104 is extremely high. Accordingly, after the jumper 20 and the substrate 10 are connected, the optical fiber 30 and the optical transmission channel 12 are precisely aligned with each other, thus ensuring a higher coupling efficiency.

Optionally, in a structure applied to the first preferable embodiment shown in FIGS. 1-8, after the jumper 20 is engaged within the second hole 104, the combination method further includes following steps of: disposing an optical fiber 30 through the jumper 20 to arrange the optical fiber 30 to correspond to the optical transmission channel 12; and disposing an optical material 50 between the substrate 10 and the jumper 20 to bind the optical fiber 30.

Optionally, in a structure applied to the second preferable embodiment shown in FIGS. 9-12, the combination method further includes following steps of: binding an optical fiber 30 to the jumper 20 by a binder 60 before the jumper 20 is engaged within the second hole 104; and binding the optical fiber 30 by an optical material 50 applied between the substrate 10 and the jumper 20 after the jumper 20 is engaged within the second hole 104 ( the first positioning portion 13 of the substrate 10) and the optical fiber 30 corresponds to the optical transmission channel 12.

The optical material 50 can improve the optical transmission, and stabilize and position the optical fiber 30; the binder 60 can stabilize and position the optical fiber 30. Whereby, it is beneficial for aligning the optical fiber 30 and the optical transmission channel 12 easily, quickly and precisely.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A combination method of an optical transmission device, including following steps of:
forming a first hole on a substrate including an optical transmission channel;
filling the first hole with a filling material;
forming an alignment mark on the filling material within the first hole;
forming a second hole on the substrate based on the alignment mark; and
connecting a jumper to the second hole and make the jumper abutted against the substrate.

2. The combination method of claim 1, wherein the first hole is formed by punching or drilling.

3. The combination method of claim 1, wherein the machining precision of forming the second hole is less than or equal to ±5 μm.

4. The combination method of claim 1, after the jumper is engaged within the second hole, further including following steps of:
disposing an optical fiber through the jumper to arrange the optical fiber to correspond to the optical transmission channel; and
disposing an optical material between the substrate and the jumper to bind the optical fiber.

5. The combination method of claim 1, further including following steps of:
binding an optical fiber to the jumper by a binder before the jumper is engaged within the second hole; and
binding the optical fiber by an optical material applied between the substrate and the jumper after the jumper is engaged within the second hole and the optical fiber corresponds to the optical transmission channel.

6. The combination method of claim 1, wherein the first hole and the alignment mark have a common center.
